(19) United States
(12) Patent Application Publication
(10) Pub. No.: US 2020/0234548 A1
(43) Pub. Date: Jul. 23, 2020

(54) ANTI-THEFT BEACH BAG

(71) Applicant: Terry Hicks, Fort Lauderdale, FL (US)

(72) Inventor: Terry Hicks, Fort Lauderdale, FL (US)

(21) Appl. No.: 16/838,738

(22) Filed: Apr. 2, 2020

Related U.S. Application Data
(63) Continuation-in-part of application No. 16/167,809, filed on Oct. 23, 2018.
(60) Provisional application No. 62/576,848, filed on Oct. 25, 2017.

(51) Int. Cl. G08B 13/14; H04W 4/029; G08B 25/00

(52) U.S. Cl. CPC G08B 13/1436; G08B 25/008; H04W 4/029

(57) ABSTRACT

An autonomous anti-theft bag incorporating a container made of rugged fabric, a self-contained assembly affixed into an outer wall of said container, having a communication device, an identification device capable of deactivating the alarm, a power source, at least one control module capable of sensing movement for operation of the system, an audible device wherein the audible device has the capability of wireless connectivity through a control module, and at least one control module capable of sensing movement including an accelerometer. A method for detecting theft of a user's autonomous anti-theft bag is also provided by using an accelerometer to detect shifts in movement to determine whether the bag has been moved, and triggering an alarm playing on said an audible device if accelerometer detects movement.

### CROSS REFERENCE TO RELATED APPLICATION

This application is a continuation-in-part of application Ser. No. 16/167,809, filed Oct. 23, 2018, which claims the benefit under 35 USC 119(e) of Provisional Patent Application Ser. No. 62/576,848, filed Oct. 25, 2017; the same is incorporated by reference herein in its entirety.

### FIELD OF INVENTION

The present invention relates to using a portable container for securing and monitoring valuables. The present invention also relates to enhancing personal freedom during recreational activities, including recreational activities at the beach.

### BACKGROUND OF THE INVENTION

Beach recreation has been a popular activity for centuries. In seasons of warm climate, people visit beaches and pools to escape the heat, swim, sunbathe, and play sports near the water. Over the years, and with the rise of cellphone and smartphone usage, beach-goers are now bringing far more valuables on the beach. A risk exists when these valuables are left unattended on the beach while the owner is away from his or her bag, such as when swimming.

In an effort to protect their valuables, owners have employed use of locked bags to keep thieves from opening the bags and stealing the valuable contents. This, however, has led to thieves stealing the bag in its entirety. The current solution is to either bury valuables in a “beach safe” where the thief may not see the valuables, use an alarm with a receiver and a separate transmitter in the owner's immediate area, or sirens that clip on to the outside of the bag and may be easily removed by the thief, but are typically difficult for the original user to deactivate.

A need has arisen in the area of security of personal property at recreational areas such as the beach or a public pool for a device that extends beyond the current limitations of technology available to a user that allows a user to keep track of his or her bag, as well as alert others that the bag has been misplaced or in possession of a thief.

### SUMMARY OF THE INVENTION

The instant invention is for an autonomous anti-theft bag comprising a container made of rugged fabric having at least one internal compartment, a self contained assembly affixed into an outer wall of said container, including at least one audible device, at least one communication device, at least one identification device capable of deactivating the alarm, at least one power source, and at least one control module capable of sensing movement for operation of the system. The at least one audible device has the capability of wireless connectivity through a control module, and capability of producing sound pressure level of at least 50 decibels from the audible device. The at least one control module capable of sensing movement comprises an accelerometer.

Further provided is a method for detecting theft of a user's autonomous anti-theft bag by providing a bag made of rugged fabric with a self contained assembly affixed into an outer wall of said container including at least one audible device, at least one communication device, at lease one control module capable of sensing movement, wherein said module is an accelerometer, at least one identification device capable of deactivating an alarm, at least one power source, and at least one control module for operation of the system, wherein at least one audible device comprises capability of wireless connectivity through a control module, and capability of producing a sound pressure level of at least 50 decibels from the at least one audible device. Further provided is using said accelerometer to detect shifts in movement to determine whether said bag has been moved, and triggering an alarm playing on said at least one audible device if accelerometer detects movement.

It is an object of this invention to provide a user with a bag with anti-theft qualities for use in areas where a user may be separated from his bag, such as a beach.

It is yet another object to provide a self-contained anti-theft bag that can be left on the beach without a user worrying about whether the bag has been tampered with or stolen.

It is accordingly an object to provide an embodiment with an application to be used on smartphones that a user may then control the system with Bluetooth connectivity of devices connected within the bag, wherein the application may track a smartphone's location, which can then be used to track the bag in the event of a theft.

It is yet another object to provide a bag that will play an audible alarm when a theft is detected to attract attention to the bag, thus deterring a thief from proceeding with the theft.

It is yet a further object to provide a user with a reliable anti-theft system for a bag.

The above and yet other objects and advantages of the invention will become apparent from the hereinafter set forth Brief Description of the Drawings, Detailed Description of the Invention, and Claims appended herewith.

### BRIEF DESCRIPTION OF THE DRAWINGS

FIG. 1 is an isometric view of an autonomous anti-theft bag.

FIG. 1A is a view of an additional optional communication device as a smart phone used with the system.

FIG. 2 is an isolated view of the self-contained assembly of the autonomous anti-theft bag of FIG. 1.

FIG. 3 is a rear view of the self-contained assembly of the autonomous anti-theft bag of FIG. 2.

FIG. 4 is an exploded view of the self-contained assembly of the autonomous anti-theft bag.

FIG. 5 is a diagram of the internal components of the ideal embodiment of the self-contained assembly of the autonomous anti-theft bag.

FIG. 6 is diagrammatical representation of how an embodiment of the system of the anti-theft bag operates.

FIG. 7 is diagrammatical representation of how an application for an embodiment of the system of the anti-theft bag operates.

### DETAILED DESCRIPTION OF THE INVENTION

The instant invention provides an autonomous anti-theft bag, which may be used at recreational areas such as parks and beaches, to prevent the theft of such bag.

Here, the term “autonomous” means self-contained. The autonomous anti-theft bag encapsulates all of the components of the system. This is because a thief, after realizing the bag is locked with no way to get in to the bag, may take the entire bag. The self-containment allows an audible alarm to play from the speakers or siren of the bag to attract attention to the bag. It is intended that the alarm be loud enough to attract others undivided attention. The sound may be that of a siren or a repetitive pre-recorded message. Since the bag is self contained, and the components are inside the bag, the thief will not be able to access them, and as a result, not be able to disable the alarm, which is attracting the attention of people nearby, as well as alerting the original owner of the bag if he is within an audible range of the bag.

This self-containment also allows for an optional use of a cellular device, such as a smart phone, to continuously track the GPS location of the thief, so that the owner and police may locate the bag and any thief in its vicinity.

The fabric bag acts as a container to securely enclose the contents inside.

While the bag can be manufactured using a number of materials, in an ideal embodiment the bag itself is comprised of a rigid fabric to prevent a would-be thief from ripping in to the bag. Thin fabrics and plastics can be easily ripped in to by hand, and even some stronger variations can be ripped easily at the seams. By providing a rugged fabric, it is increasingly harder for a person trying to get in to the bag to open it without an appropriate cutting device, something that not every person at a beach would have on himself or herself. It should be noted that while this rugged fabric is ideal for this application, other materials, such as leather, rubber, plastics, and even lighter fabrics, may be employed.

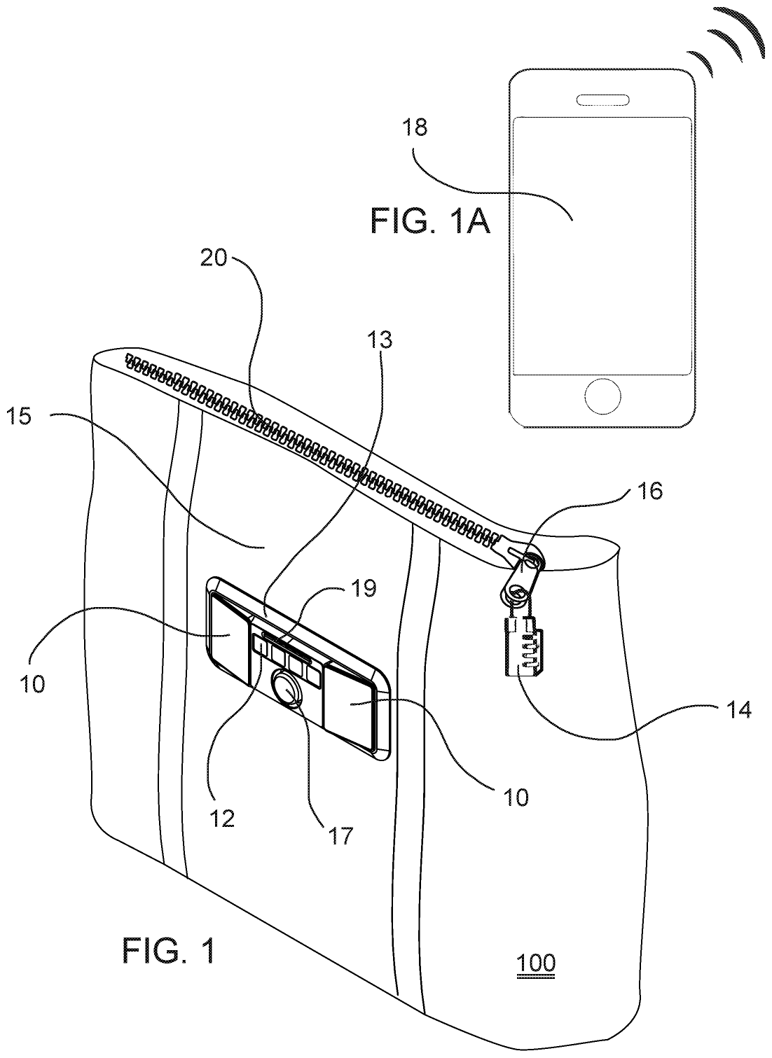

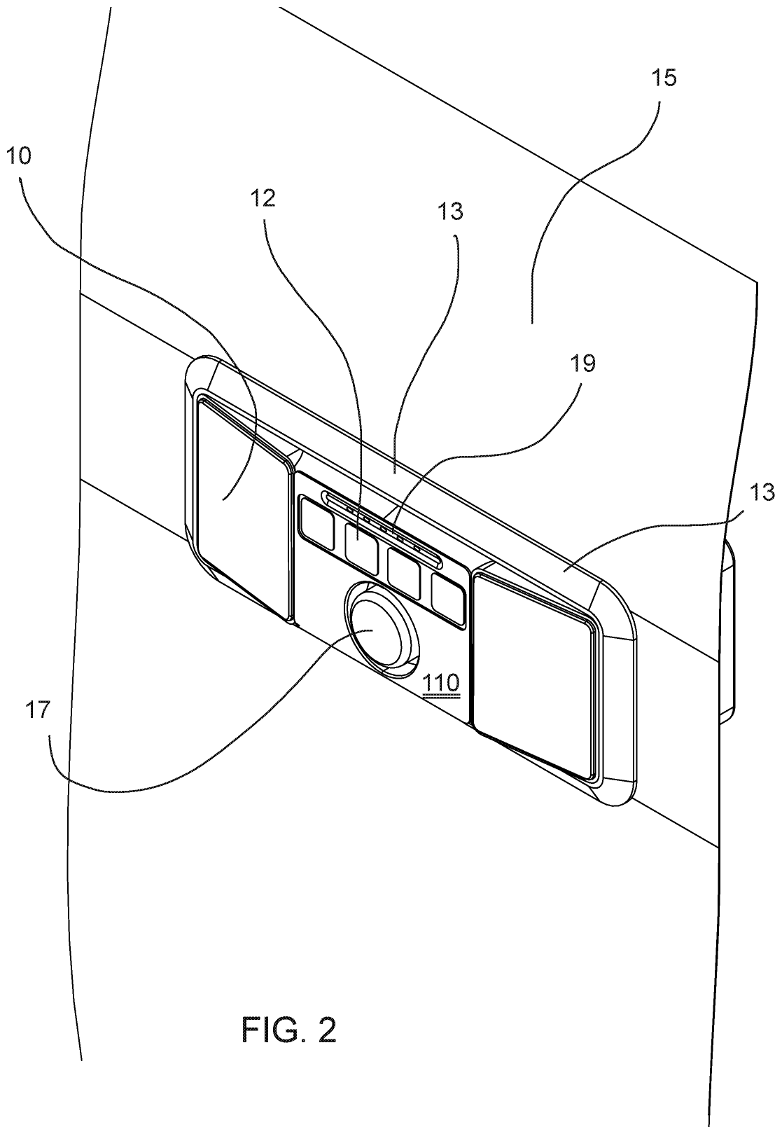

FIGS. 1 and 2 are an isometric views of an embodiment of the autonomous anti-theft beach bag 100 and an isolated view of the self contained assembly affixed to the container wall 15. Noticed are front panel 13 of self contained assembly, audible devices shown as speaker assemblies 10 and siren assembly 17, an identification device 12 in the form of a keypad, locking mechanism 14, zipper 16, and zipper teeth 20, and battery indicator 19.

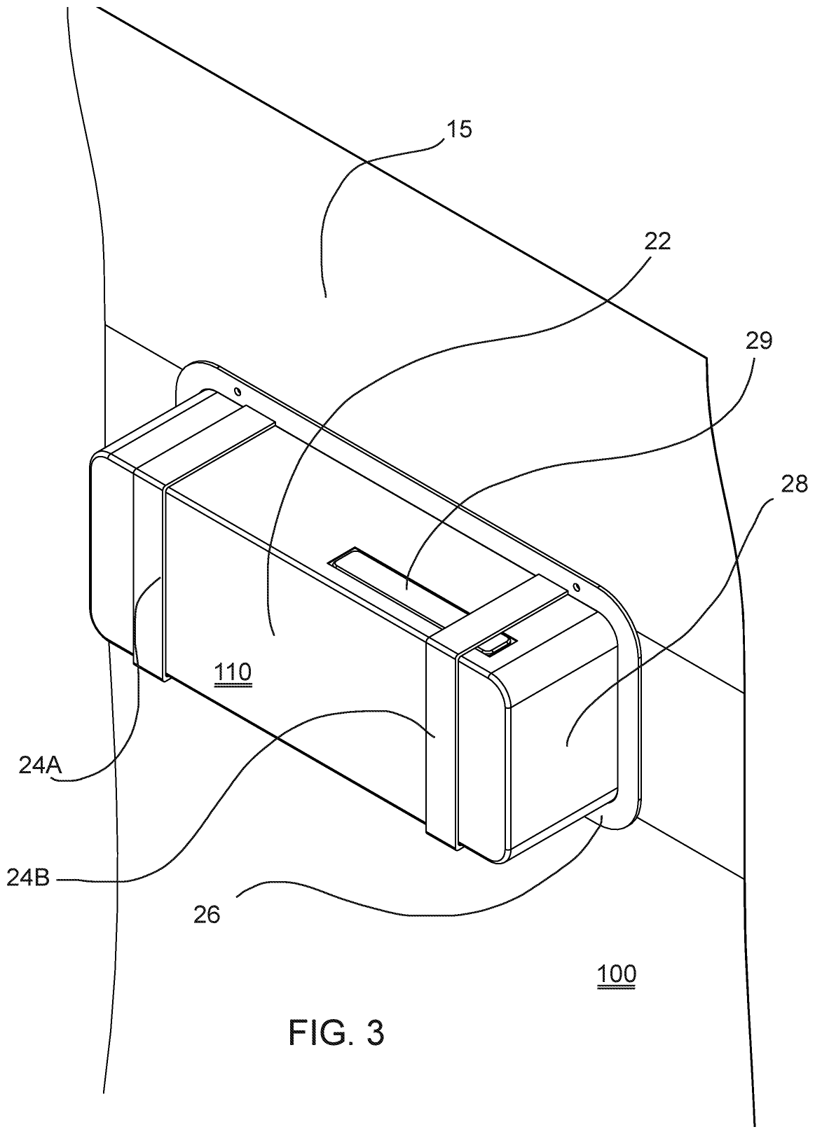

Affixed into the fabric 15, by way of screwing, clamping, sewing, gluing, or other securing means, is self-contained assembly 110. This can be seen particularly in FIGS. 1 and 2 showing the front of the assembly, and FIG. 3 showing the rear. Included in the self-contained assembly are speaker assemblies 10, which can be utilized by either an auxiliary cord or by way of Bluetooth communication. FIG. 1A is a view of an additional optional communication device as a smart phone used with the system. The speaker may pair with a communication device 18, such as a cellphone (device shown in FIG. 1A). In an embodiment where a software application on a smart phone is used to control the system, the smart phone may pair to the Bluetooth speakers to enable the bag to release an audible alarm, should the bag be moved. The audible alarm should be able to be heard from at least ten feet away, though the ideal alarm will be able to be heard from a far longer distance to attract the owner's attention. The speakers or separate siren should be capable of producing a minimum sound pressure level of about fifty decibels or greater.

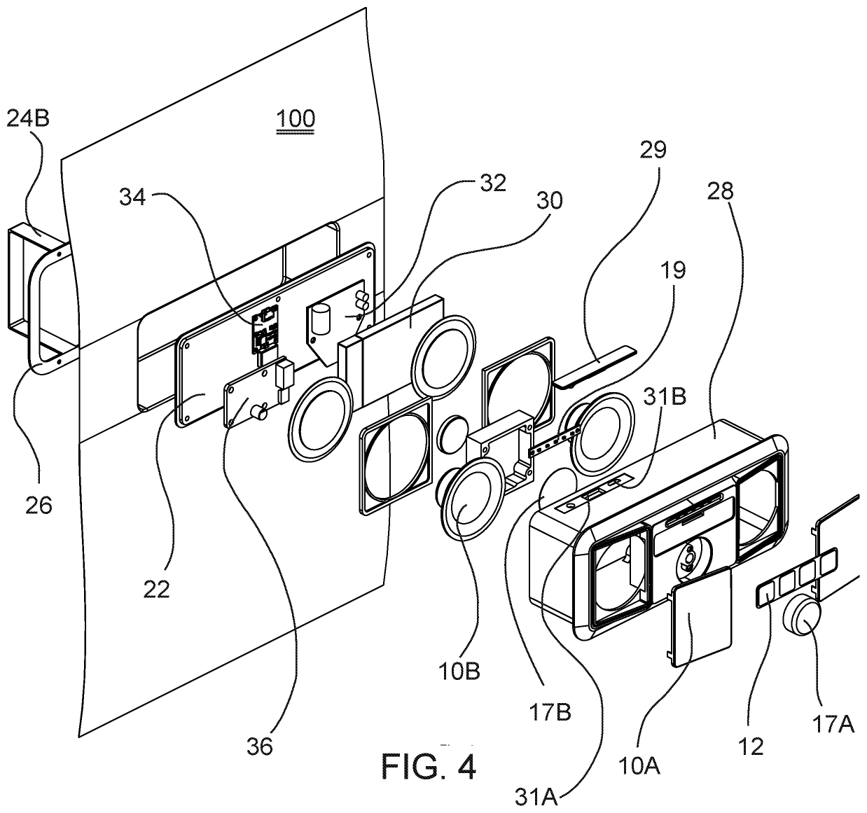

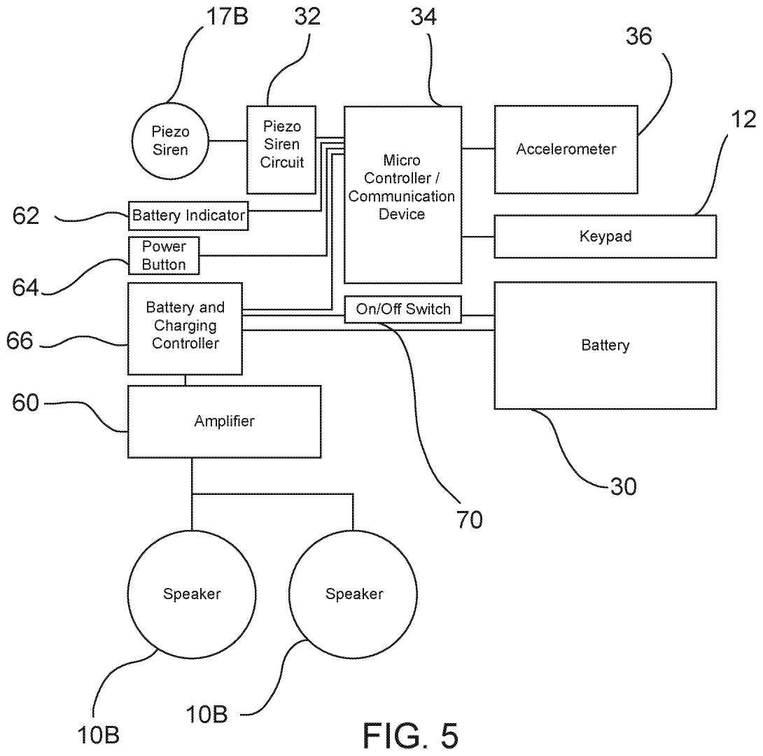

Also affixed to the bag is an identification device 12, shown in FIGS. 1 and 2, and also shown in FIGS. 4 and 5. The Identification device may be ideally a keypad, or a fingerprint reader. However, another form of biometric scanner or device to authenticate identity may be used. In FIGS. 1 and 2, the identification device is shown as a keypad. The key necessity of the identification device 12 is to pair with the communication device and allow a user to deactivate the alarm after the bag 100 is recovered.

The locking mechanism is shown in FIG. 1. The lock 14 may also be built in to the bag 100, so that it is inconspicuous. In other embodiments, the identification device 12 may also be integrated in to the locking mechanism 14.

FIG. 3 shows the rear side of the assembly 110. The figure shows a bracket for holding the assembly through use of straps 24A and 24B connected to a rim 26 of said bracket. The assembly 110 sits inside the bracket to secure the assembly to the wall 15 of the bag 100. Also shown are backplate 22, which provides access to the internal components that can be seen in FIG. 4. Assembly housing 28 and power cover 29 are also shown. Power cover 29 covers a usb port, auxiliary port, and power button.

FIG. 4 shows an exploded view of the assembly, with siren cover 17A, siren 17B, speaker cover 10A, speaker 10B, identification device 12, assembly cover 28, power cover 29, battery indicator 19, battery 30, accelerometer 36, communication device and micro-controller 34, siren circuit 32, USB connections 31A and 31B, and back plate 22. A more detailed visualization of the relationship between these elements is further shown in the schematic view of FIG. 5.

FIG. 5 shows a schematic view of the system, wherein the accelerometer 36, keypad 12, siren circuit 32 thereby connecting siren 17B, battery indicator 62, power button 64, and battery charging controller 66, are wired to the micro-controller/communication module 34. The communication module 34 controls the system and connects via Bluetooth to outside communication modules, such as a smart phone 18. The battery charging controller 66 regulates voltage coming from the battery 30, and is connected to an on/off switch 70, separate than that of the power button 64. The battery charging controller 66 also powers an amplifier 60 for speakers 10.

To operate the system as disclosed, a user will arm the alarm. If the accelerometer detects movement, it will trigger a response in the micro-controller/communication module 34, which will send a signal to the siren circuit 32 to allow siren 17B to produce an audible sound to attract the user's attention. A user may also use the system's built in speakers 10B to play such a sound. The system will continue to make noise until the user inputs a code in to the keypad 12, thereby deactivating the alarm function in the micro-controller/communication device 34, signaling the siren circuit 32 to stop the siren 17B from making sound.

The speakers 10B may also be used to play music by connecting a communication device/smartphone 18 to the micro-controller/communication device 34 by way of Bluetooth or auxiliary, and play music out of speakers 10B.

While the system has been designed to run independent of a smart phone, one embodiment of the system uses a smart phone as a communication module to run the system. The definition of a smartphone, as according to Oxford Dictionaries is, a mobile phone that performs many of the functions of a computer, typically having a touchscreen interface, Internet access, and an operating system capable of running downloaded applications. These features are important for a communication device because the smartphone will use Bluetooth connectivity to pair with the speaker assembly 10 and the identification device 12, but will also have an active cellular connection for transmitting data, such as the GPS location of the smartphone. The smartphone must be capable of sensing movement by determining GPS location, and relaying that information to a server, as well as an accelerometer to sense movement. It is ideal that the smartphone has these capabilities built in. The smartphone will also have an application installed on it to control the anti-theft alarm system.

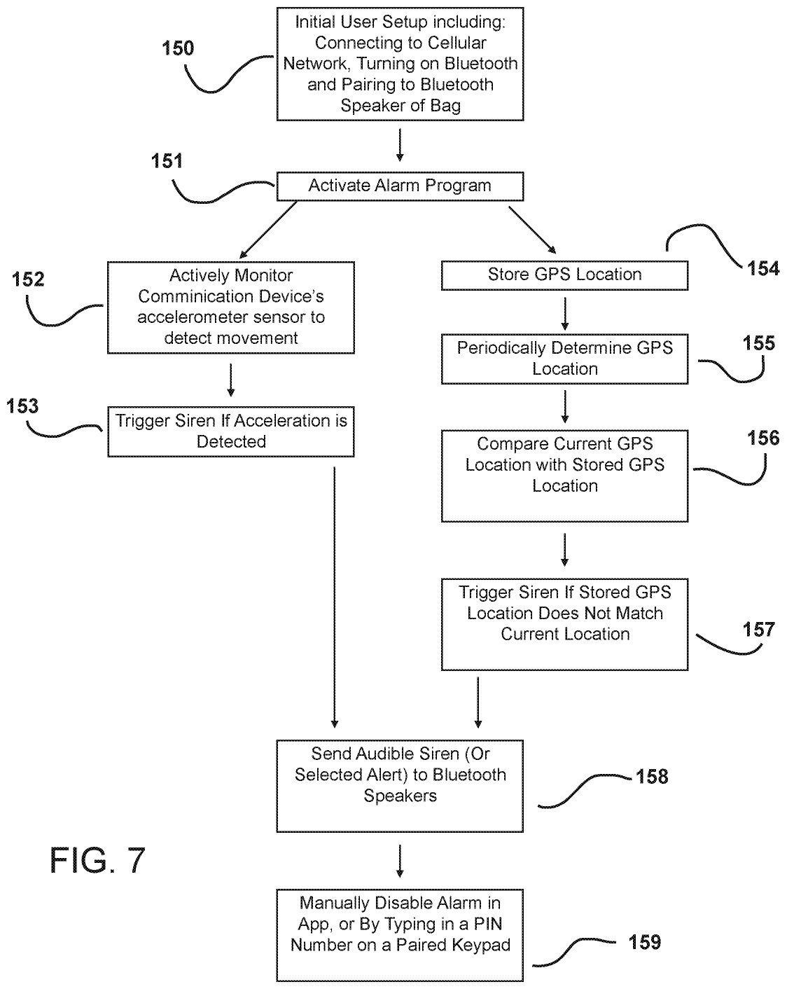

FIG. 7 further shows the principles and method of how this application works. The user performs the Initial User Setup, including connecting to a cellular network, turning on Bluetooth and pairing to the Bluetooth speaker of the bag 150, the user then activates the alarm program 151, from there the program will store, or “catalogue,” the GPS location 154. The program will periodically determine the GPS location 155 and compare it to the stored GPS location 156, as well as actively monitor the communication device's accelerometer for movement detection 152. If movement is detected from the accelerometer, or GPS sensing, a siren will be triggered 153/157. The trigger will send a signal to the Bluetooth speakers to play an audible siren 158. The siren will continue playing until the alarm is manually disabled in the smartphone app, disabling by scanning one's finger on the fingerprint reader, or by typing a PIN number on a keypad 159.

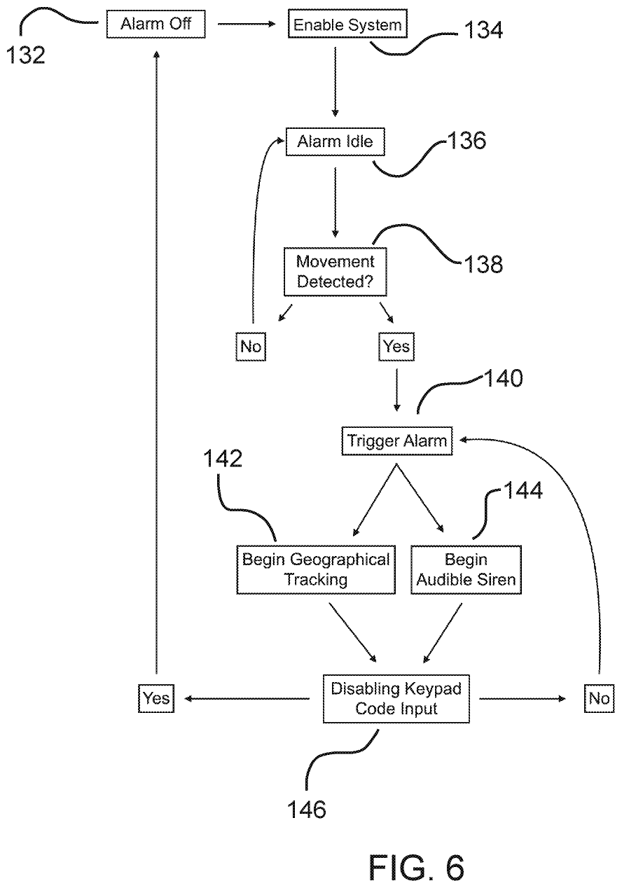

This invention also includes a method for triggering an alarm based on geographical changes. This method can be seen in FIGS. 6 and 7. FIG. 6 shows the method of the system which involves arming and enabling the system of the bag 134, having the alarm idle 136, checking if movement is detected 138, if movement is not detected, the system remains idle until movement is detected, if movement is detected, the alarm is triggered 140. Once the alarm is triggered, the system begins geographical tracking 142, and triggers an audible siren 144. If a user code is input 146, the alarm turns off. If a user code is not input, the system remains in its alarm state with an audible siren 144 and geographical tracking 142.

This method includes triggering an alarm based on geographical changes 154. This involves setting a location setting a parameter of said location, and triggering an alarm function if movement is sensed. The method involves cataloguing a user's GPS location using a smartphone GPS, done in a smartphone application. A radius is set for about three feet from the initial GPS location. The application compares its current GPS location to the catalogued GPS location. If the current smartphone's location and the catalogued GPS's location do not match, i.e., the phone is outside the set radius, an alarm is triggered. An on board accelerometer may also trigger the alarm if the sensor detects movement. This trigger sends a signal to speakers connected or paired to the smartphone to play an audible alarm. This alarm can be disabled if the user inputs a command to deactivate the alarm in the identification device. The device will have a wireless connection to work with the application on the phone.

While there has been shown and described above the preferred embodiment of the instant invention it is to be appreciated that the invention may be embodied otherwise than is herein specifically shown and described and that, within said embodiment, certain changes may be made in the form and arrangement of the parts without departing from the underlying ideas or principles of this invention as set forth in the Claims appended herewith.

I claim:

1. An autonomous anti-theft bag, the autonomous anti-theft bag comprising:
a container including at least one internal compartment;
a self-contained assembly, defined by an enclosure independent of said container including at least one internal compartment, having a front face, top side, bottom side, left and right sides, and a back surface, affixed to an outer wall of said container, comprising at least one audible device, at least one communication device, at least one identification device, at least one power source, and at least one control module for operation of the autonomous anti-theft bag, wherein the at least one audible device, at least one power source, and at least one control module are contained within the self-contained assembly;
said at least one audible device including a capability of wireless activation through a control module, and including a capability of producing sound pressure level of at least 50 decibels from the at least one audible device;
said at least one control module capable of detecting movement; and
said at least one identification device capable of deactivating an alarm.

2. The autonomous anti-theft bag as recited in claim 1, wherein said container is made of rugged fabric.

3. The autonomous anti-theft bag as recited in claim 1, wherein said at least one control module capable of detecting movement comprises an accelerometer.

4. The autonomous anti-theft bag of claim 3, wherein the at least one power source comprises a battery.

5. The autonomous anti-theft bag of claim 3, wherein the at least one power source has a power level indicator.

6. The autonomous anti-theft bag of claim 3, further comprising a locking mechanism capable of securing the bag and zipper in a closed state.

7. The autonomous anti-theft bag of claim 3, wherein the at least one audible device further comprises at least one speaker and at least one siren.

8. The autonomous anti-theft bag of claim 3, wherein the at least one audible device further comprises auxiliary cable connectivity.

9. The autonomous anti-theft bag of claim 3, wherein the at least one audible device further comprises Bluetooth connectivity.

10. The autonomous anti-theft bag of claim 9, wherein the at least one audible device comprises two speakers with Bluetooth connectivity.

11. The autonomous anti-theft bag of claim 3, wherein the at least one communication device further comprises a module capable of determining Global Positioning System (GPS) location, and relaying information to a server.

12. The autonomous anti-theft bag of claim 11, wherein the at least one communication device comprises a smartphone telephone with cellular connectivity, Bluetooth capability, built-in GPS, and accelerometer.

13. The autonomous anti-theft bag of claim 3, wherein the at least one identification device comprises a numeric keypad.

14. The autonomous anti-theft bag of claim 3, wherein the at least one identification device comprises a fingerprint reader.

15. The autonomous anti-theft bag of claim 3, wherein the at least one identification device is capable of wireless connection to and wireless deactivation of an alarm.

16. A method for detecting theft of a user's autonomous anti-theft bag, comprising:
providing a bag made of rugged fabric with a self-contained assembly affixed into an outer wall of a container, including:
(i) at least one audible device;
(ii) at least one communication device;
(iii) at least one control module capable of sensing movement, wherein said module is an accelerometer;
(iv) at least one identification device capable of deactivating an alarm;
(v) at least one power source;
(vi) at least one control module for operation of the autonomous anti-theft bag, wherein the at least one audible device comprises capability of wireless connectivity through a control module, and capability of producing a sound pressure level of at least 50 decibels from the at least one audible device;
using said accelerometer to detect shifts in movement to determine whether said bag has been moved;
triggering said alarm playing on said at least one audible device if the accelerometer detects movement.

17. The method of claim 16, further comprising:
disarming the alarm by use of said identification device if the autonomous anti-theft bag has been recovered by the user.
